(19) United States
(12) Patent Application Publication
(10) Pub. No.: US 2017/0341587 A1
(43) Pub. Date: Nov. 30, 2017

(54) VEHICLE-MOUNTED STORAGE BOX

(71) Applicants: Minghua Zhang, KunShan City (CN); Guanwen Wang, Chengdu City (CN)

(72) Inventor: Deming Wang, Beijing (CN)

(21) Appl. No.: 15/163,972

(22) Filed: May 25, 2016

(51) Int. Cl. B60R 5/04; B60R 11/00

(52) U.S. Cl. CPC B60R 5/045; B60R 11/00; B60R 2011/0029; B60R 2011/0094; B60R 2011/0036

(57) ABSTRACT

This utility model relates to a vehicle-mounted storage box, which could be a new product in the field of auto parts. The vehicle-mounted storage box includes a bottom plate, a top plate, and side plates. The top plate and bottom plate are placed horizontally with a space between them, and connected with the side plates; thus, the inner space of the vehicle-mounted storage box is enclosed by the three kinds of plates. At least one of the bottom plate, top plate, and side plates is a hollow plate made through double-layer blow-molding process. This utility model, namely the vehicle-mounted storage box, adopts hollow plates, which bring lighter weight and higher bearing capability of the storage box while ensuring its structural strength, save material cost, reduce the load of the storage box on cars, and make it more convenient to install and remove the storage box.

### FIELD OF THE INVENTION

This invention relates to the field of auto parts, and particularly relates to a vehicle-mounted storage box.

### BACKGROUND OF THE INVENTION

Vehicle-mounted storage boxes are installed in the trunk of cars and used for storing articles. However, existing vehicle-mounted storage boxes are generally made of solid and heavy plates, and thus require high material cost. Meanwhile, the heavy storage boxes increase the load on cars, and it is inconvenient to install and remove them.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

This invention is designed to provide a lighter, lower-cost vehicle-mounted storage box to solve or at least alleviate one or more technical problems of existing vehicle-mounted storage boxes.

The invention provides a vehicle-mounted storage box that comprises a bottom plate, a top plate, and side plates, with the said top plate and bottom plate being placed horizontally with a space between them and connected with the said side plates, and the inner space of the vehicle-mounted storage box being enclosed by the three kinds of plates; at least one of the bottom plate, top plate, and side plates is a hollow plate made through double-layer blow-molding process.

At least one of the two opposite inner walls of the hollow plate may be provided with protrusions on the surface, which abut against the opposite inner wall.

The opposite inner walls of the hollow plate may be provided with protrusions on the surface oppositely, and the opposite protrusions on the inner walls abut against each other.

The protrusions on the inner walls may be arranged alternately in a wavelike manner.

The top surface of the top plate may be provided with ribs.

The said vehicle-mounted storage box may also include a division plate, which is placed between the top plate and bottom plate to connect them, and located between the two oppositely arranged side plates, dividing the inner space into two parts.

The vehicle-mounted storage box may also include drawers, which can be installed in the inner space in a push-and-pull manner; each drawer comprises a drawer bottom plate and drawer side plates, with the drawer side plates being placed along the edges of the drawer bottom plate; at least one of the drawer bottom plate and drawer side plates is a hollow plate made through double-layer blow-molding process.

At least one of the two opposite inner walls of the hollow plate of the drawer may be provided with protrusions on the surface, which abut against the opposite inner wall.

The opposite inner walls of the hollow plate of the drawer may be provided with protrusions on the surface oppositely, and the opposite protrusions on the inner walls abut against each other.

The protrusions on the inner walls of the hollow plate of the said drawer may be arranged alternately in a wavelike manner.

Compared with existing vehicle-mounted storage boxes, this invention has the following beneficial effects, at least in one or more preferred embodiments. The vehicle-mounted storage box includes one or more hollow plates, which bring lighter weight and higher bearing capability of the storage box while ensuring its structural strength, save material cost, reduce the load of the storage box on cars, and make it more convenient to install and remove the storage box.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is the diagram showing the space structure of a vehicle-mounted storage box, as an embodiment of the invention, installed in a car trunk.

FIG. 2 is the diagram showing the space structure of the vehicle-mounted storage box shown in FIG. 1.

FIG. 3 is the diagram showing the vertical profile of the vehicle-mounted storage box shown in FIG. 1.

FIG. 4 is the enlarged diagram showing the area A in FIG. 3.

FIG. 5 is the diagram showing the vertical profile of the vehicle-mounted storage box shown in FIG. 1 from another angle.

FIG. 6 is the enlarged diagram showing the area B in FIG. 5.

### DETAILED DESCRIPTION OF THE EMBODIMENTS

The invention is hereinafter described in detail with reference to an embodiment and the drawings, to better illustrate the technical problem the invention is designed to solve, as well as the technical solution and beneficial effects. It should be understood that the embodiment described hereinafter is illustrative and non-restrictive in every respect.

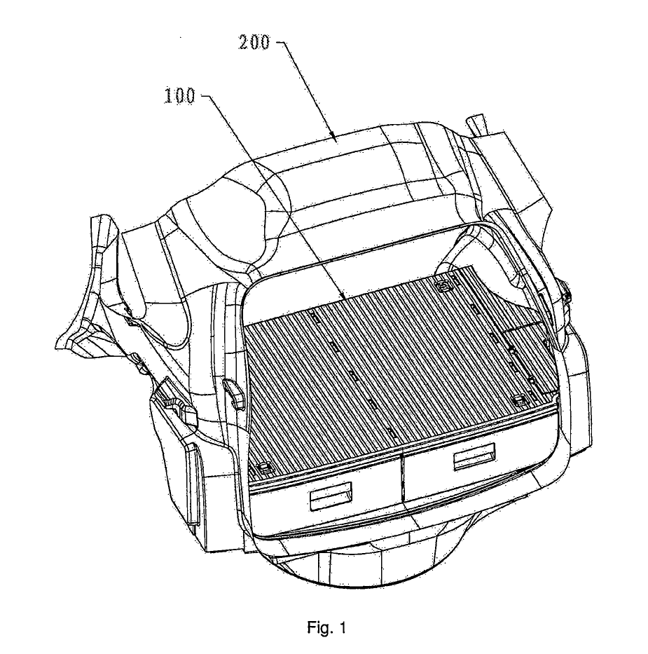

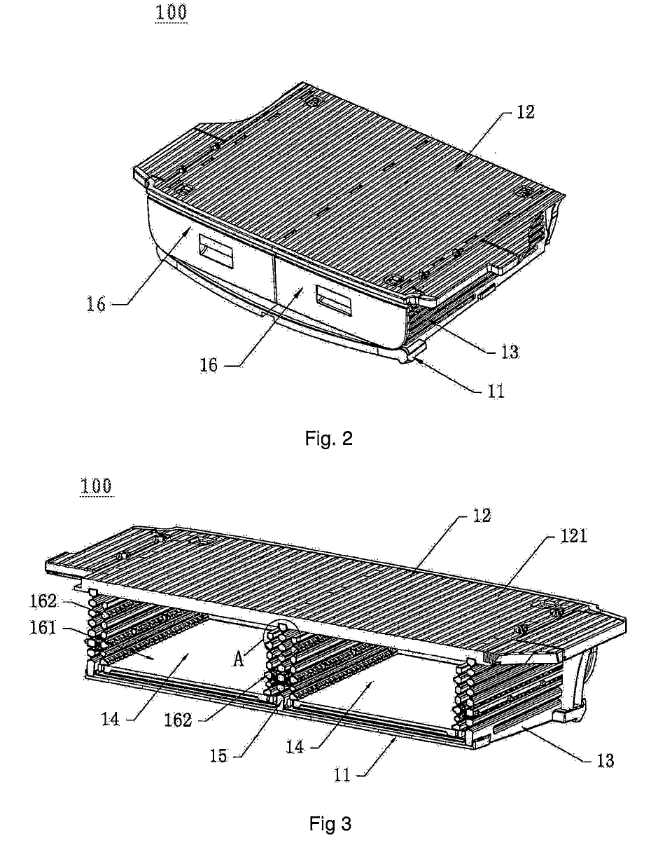

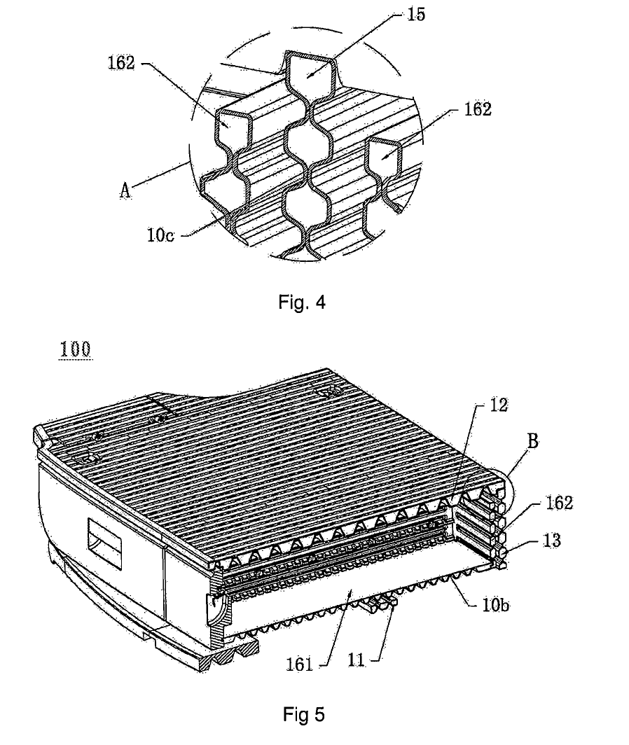

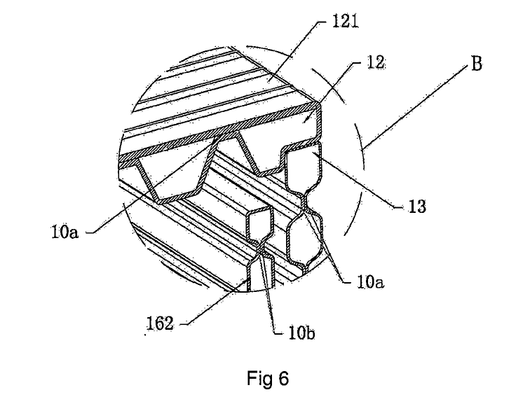

An embodiment of the invention, namely a vehicle-mounted storage box, is shown in FIG. 1-FIG. 6. The vehicle-mounted storage box 100 comprises a bottom plate 11, a top plate 12, and side plates 13, with the top plate 12 and bottom plate 11 being placed horizontally with a space between them and connected with the side plates 13, and the inner space 14 of the vehicle-mounted storage box being enclosed by the three kinds of plates 11, 12, and 13; at least one of the bottom plate 11, top plate 12, and side plates 13 is a hollow plate made through double-layer blow-molding process; in this embodiment, the bottom plate 11, top plate 12, and side plates 13 are all hollow plates made through double-layer blow-molding process.

At least one of the two opposite inner walls of the said hollow plate is provided with protrusions on the surface, which abut against the opposite inner wall. Specifically, one inner wall of the two opposite inner walls of the top plate 12 is provided with protrusions 10a on the surface, which abut against the opposite inner wall; the opposite inner walls of the bottom plate 11 and side plates 13 are provided with protrusions 10a on the surface oppositely, and the opposite protrusions 10a on the inner walls abut against each other; the protrusions 10a on the inner walls of the bottom plate 11, top plate 12, and side plates 13 are arranged alternately in a wavelike manner.

In addition, the said vehicle-mounted storage box 100 also includes a division plate 15 and drawers 16; the division plate 15 is placed between the top plate 12 and bottom plate 11 to connect them, and located between the two oppositely arranged side plates 13, dividing the inner space 14 into two parts; The drawers 16 can be installed in the inner spaces 14 in a push-and-pull manner; each drawer comprises a drawer bottom plate 161 and drawer side plates 162, with the drawer side plates 162 being placed along the edges of the drawer bottom plate 161; at least one of the drawer bottom plate 161 and drawer side plates 162 is a hollow plate made through double-layer blow-molding process. In this embodiment, the drawer bottom plate 161 and drawer side plates 162 are all hollow plates made through double-layer blow-molding process; one inner wall of the two opposite inner walls of the drawer bottom plate 161 is provided with protrusions 10b on the surface, which abut against the opposite inner wall; the opposite inner walls of the drawer side plates 162 are provided with protrusions 10b on the surface oppositely, and the opposite protrusions 10b on the inner walls abut against each other; the protrusions 10b on the inner walls are arranged alternately in a wavelike manner. The opposite inner walls of the division plate 15 in this embodiment are provided with protrusions 10c on the surface oppositely, and the opposite protrusions 10c on the inner walls abut against each other; the protrusions 10c on the inner walls are arranged alternately in a wavelike manner.

By virtue of the protrusions on the said bottom plate 11, top plate 12, side plate 13, drawer bottom plate 161, drawer side plates 162, and division plate 15, both the inner walls of the hollow plates can support each other, thus guaranteeing the light and thin plates can provide great bearing capacity.

Further, the top surface of the top plate 12 is provided with ribs 121 to enhance the vehicle-mounted storage box 100's bearing capacity. Users can place articles on the top plate 12 of the vehicle-mounted storage box 100, thus realizing rational utilization of the limited room in the car trunk 200.

The bottom plate 11, top plate 12, side plates 13, division plate 15, and drawers 16 of the above-described vehicle-mounted storage box 100 all adopt the hollow structure made through double-layer blow-molding process, which can bring lighter weight and higher bearing capability of the storage box while ensuring its overall structural strength, save material cost, reduce the load of the storage box on cars, and make it more convenient to install and remove the storage box.

The above content is only the description of a preferred embodiment of the invention, and not intended to restrict the scope of the invention. Any modifications, equivalent replacements, and improvements made in accordance with principles and meaning of the invention shall be included in the protection scope of this patent.

What is claimed is:

1. A vehicle-mounted storage box comprising: a bottom plate, a top plate, and side plates, with the said top plate and bottom plate being placed horizontally with a space between them and connected with the said side plates, and the inner space of the vehicle-mounted storage box being enclosed by the three kinds of plates, wherein at least one of the bottom plate, top plate, and side plates is a hollow plate made through double-layer blow-molding process.

2. The vehicle-mounted storage box according to claim 1, wherein at least one of the two opposite inner walls of the said hollow plate is provided with protrusions on the surface, which abut against the opposite inner wall.

3. The vehicle-mounted storage box according to claim 2, wherein the protrusions on the said inner walls are arranged alternately in a wavelike manner.

4. The vehicle-mounted storage box according to claim 2, wherein the opposite inner walls of the said hollow plate are provided with protrusions on the surface oppositely, and the opposite protrusions on the inner walls abut against each other.

5. The vehicle-mounted storage box according to claim 4, wherein the protrusions on the said inner walls are arranged alternately in a wavelike manner.

6. The vehicle-mounted storage box according to claim 1, wherein the top surface of the said top plate is provided with ribs.

7. The vehicle-mounted storage box according to claim 1, wherein the said vehicle-mounted storage box further includes a division plate, which is placed between the said top plate and bottom plate to connect them, and located between the two oppositely arranged side plates, dividing the said inner space into two parts.

8. The vehicle-mounted storage box according to claim 1, wherein the said vehicle-mounted storage box further includes drawers, which can be installed in the said inner spaces in a push-and-pull manner; each drawer comprises a drawer bottom plate and drawer side plates, with the said drawer side plates being placed along the edges of the said drawer bottom plate; at least one of the said drawer bottom plate and drawer side plates is a hollow plate made through double-layer blow-molding process.

9. The vehicle-mounted storage box according to claim 8, wherein at least one of the two opposite inner walls of the hollow plate of the said drawer is provided with protrusions on the surface, which abut against the opposite inner wall.

10. The vehicle-mounted storage box according to claim 9, wherein the opposite inner walls of the hollow plate of the said drawer are provided with protrusions on the surface oppositely, and the opposite protrusions on the inner walls abut against each other.

11. The vehicle-mounted storage box according to claim 10, wherein the protrusions on the inner walls of the hollow plate of the said drawer are arranged alternately in a wavelike manner.

12. The vehicle-mounted storage box according to claim 2, wherein the said vehicle-mounted storage box further includes drawers, which can be installed in the said inner spaces in a push-and-pull manner; each drawer comprises a drawer bottom plate and drawer side plates, with the said drawer side plates being placed along the edges of the said drawer bottom plate; at least one of the said drawer bottom plate and drawer side plates is a hollow plate made through double-layer blow-molding process.

13. The vehicle-mounted storage box according to claim 12, wherein at least one of the two opposite inner walls of the hollow plate of the said drawer is provided with protrusions on the surface, which abut against the opposite inner wall.

14. The vehicle-mounted storage box according to claim 13, wherein the opposite inner walls of the hollow plate of the said drawer are provided with protrusions on the surface oppositely, and the opposite protrusions on the inner walls abut against each other.

15. The vehicle-mounted storage box according to claim 14, wherein the protrusions on the inner walls of the hollow plate of the said drawer are arranged alternately in a wavelike manner.

16. The vehicle-mounted storage box according to claim 4, wherein the said vehicle-mounted storage box further includes drawers, which can be installed in the said inner spaces in a push-and-pull manner; each drawer comprises a drawer bottom plate and drawer side plates, with the said drawer side plates being placed along the edges of the said drawer bottom plate; at least one of the said drawer bottom plate and drawer side plates is a hollow plate made through double-layer blow-molding process.

17. The vehicle-mounted storage box according to claim 16, wherein at least one of the two opposite inner walls of the hollow plate of the said drawer is provided with protrusions on the surface, which abut against the opposite inner wall.

18. The vehicle-mounted storage box according to claim 17, wherein the opposite inner walls of the hollow plate of the said drawer are provided with protrusions on the surface oppositely, and the opposite protrusions on the inner walls abut against each other.
